(19) United States
(12) Patent Application Publication
(10) Pub. No.: US 2007/0067202 A1
(43) Pub. Date: Mar. 22, 2007

(54) Method and system for establishing relationship between business organizations

(76) Inventors: Gary Igor Siroko, Lincolnwood, IL (US); Siedle Rubesh Jacobs, Columbus, OH (US)

Correspondence Address: Daniel H. Golub, 1701 Market Street, Philadelphia, PA, 19103, US

(21) Appl. No.: 11/489,044

(22) Filed: Jul. 18, 2006

Related U.S. Application Data
(60) Provisional application No. 60/701,127, filed on Jul. 20, 2005.

(51) Int. Cl. G06Q 99/00; G05B 19/418; G06F 15/02; G06F 9/46

(52) U.S. Cl. 705/9; 705/1; 705/8

(57) ABSTRACT

A relationship between a first business organization, which offers a plurality of services, and one or more second business organizations is established. Vendors that support business activity applications are identified. The business activity applications are associated with a plurality of business processes and technology. A business relationship is negotiated with the vendors using at least one of a bargaining power of the first business organization, an existing relationship between the first business organization and the vendors, a volume of potential business for the vendor based on an aggregation of needs of the second business organization, and brand recognition of the first business organization. A portal is maintained through which the second business organization accesses, using a single interface, the business activity applications. In connection with maintaining the portal, the technology and business processes associated with the business activity applications are aggregated and integrated, respectively, with the technology and business processes associated with other of the business activity applications. A relationship between the first and second organizations is a established as a result of the portal, thereby allowing the first business organization to performs services for the second business organization.

### CROSS REFERENCE TO RELATED APPLICATIONS

This application claims priority to U.S. Provisional Patent Application No. 60/701,127, filed Jul. 20, 2005, which is hereby incorporated by reference in its entirety.

### FIELD OF THE INVENTION

The present invention relates to leveraging portal technology and establishing relationships between business organizations in connection therewith.

### BACKGROUND OF THE INVENTION

Many companies, and small business in particular, wrestle with the same strategic and operational issues that large firms face, but have limited ability to respond. For example, such businesses face problems associated with sharing company information, collaborating on company issues, and providing access to information external to the company. In order to stay competitive, companies must push to be more efficient, which means they can spend less time completing tasks and must make business assessments quickly. Some companies maintain a mobile workforce who need access to information anytime, anywhere. Many small businesses have limited capital resources and, thus, are unwilling to spend capital to upgrade/switch to new and better applications. Many applications used in connection with businesses are associated with high support and maintenance costs. Supporting multiple applications locally is burdensome on companies. In addition, security is a concern, as well as disaster recovery and business continuity. Finally, such businesses have a need for applications that will support future growth.

Small businesses often rely on inefficient manual processes because they do not have adequate capital resources to make investments in process automation and efficiency. Larger competitors that are able to make automation investments possess more profitability and efficiencies than their small business competitors. Tools designed to automate tasks and increase efficiency are commercially available; however, the cost is prohibitive for many small businesses. Small businesses cannot bear the cost of the technology infrastructure required to support efficiency applications, and commercially available tools are not scalable to the needs of small businesses. Increasingly, larger firms are employing integrated technology solutions to manage their processes, e.g., supply chain management and sales fulfillment, and expect their business partners to be able to integrate into these processes. Large businesses that have realized reduced operating costs from automation require that their business partners update their technologies to integrate into these processes, or risk losing the relationship. On average, small businesses spend as much as 10% of their revenue on non-production expenses (e.g., office supplies, data processing etc.). Small businesses lack the buying power to negotiate better purchasing terms for commodity-type products and services that some of their larger competitors enjoy.

Small businesses typically rely on off-the-shelf office software to fulfill their word processing and accounting needs. The information on which these businesses function are typically stored on a particular PC's hard drive and not integrated or easily accessible. Information technology concepts that large firms consider business critical such as enterprise resource planning, customer relationship management, inventory management and procurement, local area networks, high-speed internet connections, and management of data and information are not often considered by small businesses.

### SUMMARY OF THE INVENTION

The present invention is directed to a method and system for creating a relationship between a first business organization, which offers a plurality of services, and one or more second business organizations. Vendors that support business activity applications are identified. At least some of the business activity applications are each supported by a different vendor. Each of the business activity applications are associated with a plurality of business processes and technology. A business relationship is negotiated with the vendors using at least one of a bargaining power of the first business organization, an existing relationship between the first business organization and the vendors, a volume of potential business for the vendor based on an aggregation of needs of the second business organization, and brand recognition of the first business organization. A portal is maintained through which the second business organization accesses, using a single interface, the business activity applications. In connection with maintaining the portal, at least some of the technology associated with at least one of the business activity applications is aggregated with at least some of the technology associated with at least one other of the business activity applications. Also, through the portal, one or more of the business processes associated with at least one of the business activity applications are integrated with one or more of the business processes associated with at least one other of the business activity applications. As a result of, at least in part, maintaining the portal, a relationship between the first business organization and the second business organization is established. In connection with this relationship, the first business organization performs its services for the second business organization.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and, together with the description, serve to explain the principles of the invention.

In the drawings:

FIG. 1 is a diagram illustrating the negotiation between a portal management company and a plurality of vendors;

FIG. 2 is a representation of the portal that may be used in connection with the present invention;

FIG. 3 is a system diagram illustrating an exemplary computer architecture that may be used in connection with the present invention; and

FIG. 4 is a flow diagram illustrating a preferred embodiment of a method of the present invention.

### DETAILED DESCRIPTION OF THE PREFERRED EMBODIMENTS

The present invention leverages the use of portal technology to create a network-based system that is useful predominantly, but not exclusively, to small businesses. While this detailed description refers to small businesses, the present invention is equally applicable to any business facing the problems similar to those faced by small businesses that would benefit from the present invention. The portal allows for the delivery of integrated, customizable business applications at an affordable price. Through the portal delivery system, two primary benefits are delivered to customers: affordable access to leading edge business management applications, such as accounting and human resources, and preferred discounts on products and services. By helping businesses address these challenges through the portal, an opportunity to strengthen relationships with such business customers is presented.

Generally speaking, portals are web-based systems that provide secure, personalized, single point, integrated access to business applications. Portals can increase user productivity by providing personalized access to desired information by employing a common gateway as an access point into enterprise data and applications. The portal's integrative nature enables workers to bridge a variety of databases, documents and data across a business, with the intent to simplify workers' interactions with customers, suppliers, partners and fellow employees. Portals support many business capabilities, including searching across multiple repositories; single authentication and authorization to multiple resources; a customized user interface for authorized users to manage content; delivery of personalized content using a rules based engine; access and integration to enterprise applications; acquiring and publishing content from other sources; collaboration; content, document and knowledge management; and internationalization and localization.

Using this system described herein, businesses are provided access to, and assistance with, integrated software applications for business functions, such as (by way of example) accounting, finance, purchasing, payroll and human resource record-keeping. The applications and supporting company information are hosted and run from a remote data center, thereby providing security, data back-up and disaster recovery support.

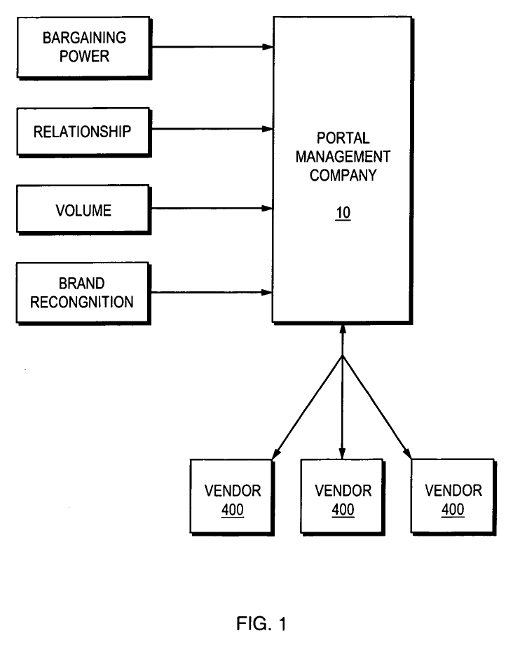

With reference to FIG. 1, the company hosting and/or managing the portal (“portal management company”) 10 identifies vendors 400 and negotiates the deals on behalf of the companies that are to use the portal. The portal management company uses its bargaining power, an existing relationship between the portal management company and the vendors, a volume of potential business for the vendor based on an aggregation of needs of the companies that are to use the portal, and/or the portal management company's brand recognition to negotiate favorable terms. While the portal management company may own one or more of the business applications accessible via the portal, in the preferred embodiment, many of such business applications are owned by third parties.

Once logged into the portal, based on their job responsibilities, users (e.g., employees of the companies that are to use the portal) can access company information and announcements; industry and general news information; integrated human resources, payroll, finance/accounting and eProcurement functions, by way of example. Each of these business functions includes a full set of associated tasks. A “dashboard” with up-to-date statistics/internal metrics related to the company's performance and status may also be provided. When an authorized user enters information into one functional area of the system, it is automatically entered into all other appropriate functional areas. For example, when a new employee's information is entered into the human resources area, all pertinent information is entered into the payroll processing area as well. If supplies are to be purchased for the new employee, that data is entered into the eProcurement function, an order for the supplies is generated and a message requesting authorization is sent to the designated manager/approver. When the purchased products are received, data is entered into the accounts payable system and a reminder to pay a pending invoice is automatically generated and sent to the person responsible for that function.

The services offered via the portal may be provided “a la carte.” However, such services may also be provided in bundles, where such bundles are created based on the life cycle stage of the company and/or the industry with which the company is affiliated. For example, start up companies may need commodity products and services, as well as technology infrastructure services. Companies in growth stage will need, in addition, business administration services. Companies that have reached profitability may need commodity products and services, business administration services and strategic consulting services. Finally, mature companies may need transition services, as well as some of the aforementioned services. By way of further example, companies in a particular industry, such as a small lawfirm or other professional services firm, may have need for accounting and office supply services, whereas a business that sells product may have additional needs relating to sales management, marketing, and human resources.

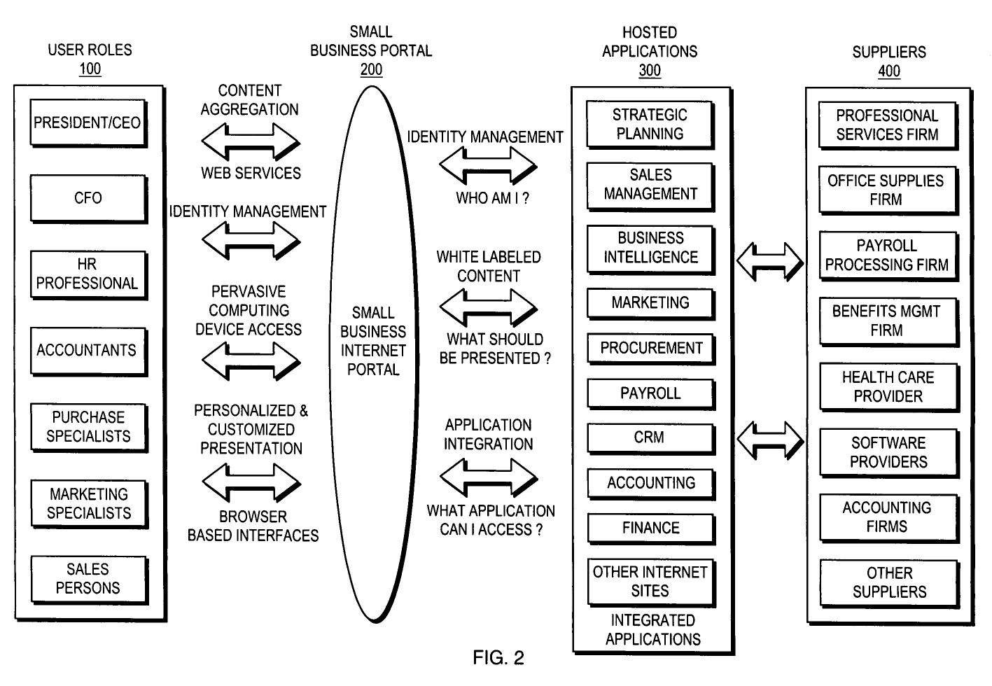

FIG. 2 is a conceptual representation of an exemplary portal configuration that may be used in connection with the present invention. Users 100 accessing the portal may be assigned different roles, and access to different functionality of the portal 200, based on such roles. The roles shown in FIG. 2 are exemplary only; others can be used within the scope of the present invention. The portal 200 (hosted and/or maintained by the portal management company) sits between the users 100 (associated with a business organization) and the hosted business activity applications 300. Such business activity applications are associated with different business processes and technologies. Business activity applications 300 shown in FIG. 2 are exemplary only; others can be used within the scope of the invention. Vendors 400 provide the business activity applications 300. As can be seen from FIG. 2, data, content and application integration can be achieved using the portal. Content and applications are seamlessly connected. The system is highly scalable through its “plug-and-play” architecture and development framework. It allows for single sign-on and user profile management. Multiple application areas are managed through a centralized location.

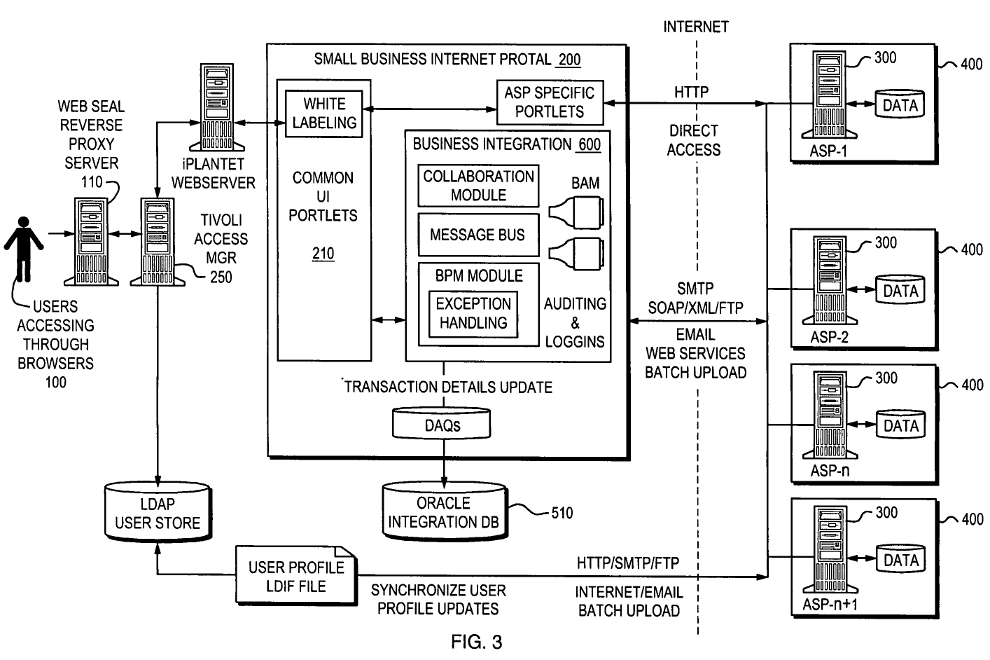

FIG. 3 provides a more detailed illustration of a computer architecture that may be used in connection with implementing the present invention. Users 100 seeking access to the portal 200 are first routed to a security server 110. Security server 10 will host the repository of all the users, groups and authorization permissions. Once the user is validated against the security server, he can then access the services hosted on the portal 200. Based on the user's credential and other metadata information, the portal 200 will automatically identify the organization to which the user 100 belongs and accordingly display the appropriate content. The portal framework uses portlets 210 to display the contents from the websites of vendors 400, thereby providing users 100 with a single user interface to business activity applications 300 of vendors 400.

The exemplary architecture is essentially divided into three distinct parts: the security server node, the portal server node, the database server node; and the integration server node. The security server node displays the primary logon page to the user 100. After the user enters his user identification and password, he is authenticated using this layer. The information necessary for authentication is stored in the user repository 510. The mapping of individual user identifications and passwords with applications 300 is handled by creating junctions inside access manager 250. The portal server node provides the customization and personalization, as well as content display features. Whenever a user logs in, the portal engine displays the appropriate set of portlets based on the user's login credentials and also displays the user's organization-specific branding. The user may also be given the ability to change the look and feel of the pages by placing the portlets based on his preferences. The business activity applications will be accessed by the user through portlets, as discussed above. The database server node 500 stores information gathered in connection with the portlet. The integration server node 600 handles transactions between business activity applications. It provides the capabilities necessary to handle a given business transaction, interactions with vendors 400, coordinating the business processes, exception handling services, auditing service and business activity monitoring services. The portal node interacts with the integration node 600, either to trigger the business processes or to display the information sent by the integration node 600.

Access to this system requires minimal capital investment (i.e., in the preferred embodiment, a start-up cost and a monthly fee). The monthly fee may be based on, e.g., the number of employees; the number of users for specific functions; and user support options.

Professional services, training, and customer support for all of the business applications offered via the portal are centrally managed. In one embodiment, a tiered customer support model is implemented. In connection with this model, level 1 support will include a help desk that will accept an inbound call, verify that the customer has a valid support contract, enter a ticket into a problem management system, and attempt to troubleshoot. If unable to assist, level 2 support will be contacted. Level 2 support will still be located within the call center and will provide expertise for each particular application 300. Level 3 support will be provided by the vendor 400 associated with a given application 300. Maintenance is provided by the supplier of the application. Upgrades to the system/applications are automatically provided on a regular basis.

The portal management company is given the opportunity to up-sell their other services to the companies that have subscribed to the portal. For example, the portal management company may offer, as its core service, insurance and financial products. By reaching out to small and other businesses with need for the portal, and supporting such businesses using the portal, the portal management company is given an opportunity to establish a relationship with such businesses and sell to such businesses its core offering (e.g., insurance and financial products).

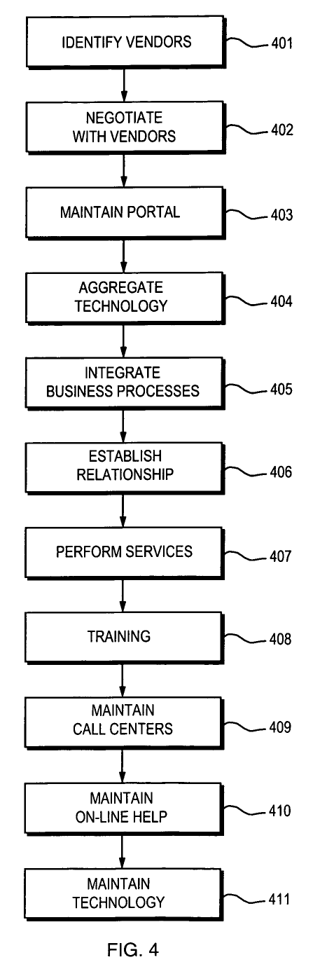

FIG. 4 is a flow diagram illustrating a preferred embodiment of a method of the present invention. Vendors that support business activity applications are identified in step 401. At least some of the business activity applications are each supported by a different vendor. Each of the business activity applications are associated with a plurality of business processes and technology. A business relationship is negotiated with the vendors using at least one of a bargaining power of the first business organization, an existing relationship between the first business organization and the vendors, a volume of potential business for the vendor based on an aggregation of needs of the second business organization, and brand recognition of the first business organization in step 402. A portal is maintained, in step 403, through which the second business organization accesses, using a single interface, the business activity applications. In connection with maintaining the portal, at least some of the technology associated with at least one of the business activity applications is aggregated with at least some of the technology associated with at least one other of the business activity applications, in step 404. Also, through the portal, one or more of the business processes associated with at least one of the business activity applications are integrated with one or more of the business processes associated with at least one other of the business activity applications in step 405. As a result of, at least in part, maintaining the portal, a relationship between the first business organization and the second business organization is established in step 406. In connection with this relationship, the first business organization performs its services for the second business organization in step 407.

In step 408, a single training experience comprising training activities associated with all of the business activity applications is provided. In step 409, a call center that supports all of the business activity applications is maintained. In step 410, an on-line help service that supports all of the business activity applications is maintained. In step 411, the technology for all of the business activity applications is managed, comprising at least one of providing upgrades, conducting maintenance, scanning for viruses. Many of the steps described with reference to FIG. 4 can be performed in any order.

It will be appreciated by those skilled in the art that changes could be made to the embodiments described above without departing from the broad inventive concept thereof. It is understood, therefore, that this invention is not limited to the particular embodiments disclosed, but is intended to cover modifications within the spirit and scope of the present invention as defined in the appended claims.

We claim:

1. A method for creating a relationship between a first business organization and at least one second business organization, wherein the first business organization offers a plurality of services, comprising:
(A) identifying a plurality of vendors each supporting at least one business activity application,
wherein at least some of the business activity applications are each supported by a different vendor and wherein each of the business activity applications are associated with a plurality of business processes and technology;
(B) negotiating a business relationship with the vendors using at least one of a bargaining power of the first business organization, an existing relationship between the first business organization and the vendors, a volume of potential business for the vendor based on an aggregation of needs of the second business organization, and a brand recognition of the first business organization;
(C) maintaining a portal through which the second business organization accesses, through a single interface, the business activity applications, said maintaining comprising:
(i) aggregating at least some of the technology associated with at least one of the business activity applications with at least some of the technology associated with at least one other of the business activity applications; and
(ii) integrating one or more of the business processes associated with at least one of the business activity applications with one or more of the business processes associated with at least one other of the business activity applications; and
(D) as a result of, at least in part, step (C), establishing a relationship between the first business organization and the second business organization comprising performing by the first business organization at least one of the services for the second business organization.

2. The method of claim 1 further comprising:
(E) providing a single training experience comprising training activities associated with all of the business activity applications.

3. The method of claim 1 further comprising:
(F) maintaining a call center that supports all of the business activity applications.

4. The method of claim 1 further comprising:
(G) maintaining an on-line help service that supports all of the business activity applications.

5. The method of claim 1 further comprising:
(H) managing the technology for all of the business activity applications comprising at least one of providing upgrades, conducting maintenance, scanning for viruses.

6. The method of claim 1, wherein each of the second business organizations and the business activity applications are associated with at least one industry type, further comprising:
(I) grouping the business activity applications according to the industry type; and
(J) offering the business activity applications in accordance with the groupings.

7. A system to support a relationship between a first business organization and at least one second business organization, comprising:
the first business organization that offers a plurality of services;
the at least one second business organizations;
a plurality of vendors each supporting at least one business activity application,
wherein at least some of the business activity applications are each supported by a different vendor and wherein each of the business activity applications are associated with a plurality of business processes and technology; and
wherein a business relationship is negotiated between the first business organization and the vendors using at least one of a bargaining power of the first business organization, an existing relationship between the first business organization and the vendors, a volume of potential business for the vendor based on an aggregation of needs of the second business organization, and a brand recognition of the first business organization;
a portal through which the second business organization accesses, through a single interface, the business activity applications;
wherein, through the portal, at least some of the technology associated with at least one of the business activity applications is aggregated with at least some of the technology associated with at least one other of the business activity applications; and one or more of the business processes associated with at least one of the business activity applications is integrated with one or more of the business processes associated with at least one other of the business activity applications;
wherein a relationship between the first business organization and the second business organization is established comprising performing by the first business organization at least one of the services for the second business organization.

8. The system of claim 7 wherein a single training experience is provided comprising training activities associated with all of the business activity applications.

9. The system of claim 7 further comprising:
a call center that supports all of the business activity applications.

10. The system of claim 7 further comprising:
an on-line help service that supports all of the business activity applications.

11. The system of claim 7 wherein the technology for all of the business activity applications is managed, the managing comprising at least one of providing upgrades, conducting maintenance, scanning for viruses.

12. The system of claim 7, wherein each of the second business organizations and the business activity applications are associated with at least one industry type and wherein the business activity applications are grouped according to the industry type; and the business activity applications are offered in accordance with the groupings.
